(19) United States
(12) Patent Application Publication
(10) Pub. No.: US 2006/0029082 A1
(43) Pub. Date: Feb. 9, 2006

(54) Communication apparatus, equipment message processing program, and computer readable medium

(76) Inventor: Tsutomu Yuki, Tokyo (JP)

Correspondence Address: DICKSTEIN SHAPIRO MORIN & OSHINSKY LLP, 2101 L Street, NW, Washington, DC, 20037, US

(21) Appl. No.: 11/148,370

(22) Filed: Jun. 9, 2005

(30) Foreign Application Priority Data
Jun. 10, 2004 (JP) 2004-172792
May 2, 2005 (JP) 2005-134258

(51) Int. Cl. H04L 12/56

(52) U.S. Cl. 370/399

(57) ABSTRACT

A communication apparatus implementing plural applications is disclosed. The communication apparatus includes an equipment message processing part that is configured to receive a message transmitted from equipment connected to a network that indicates the state of the equipment, and transmit message information pertaining to the received message to the applications.

### BACKGROUND OF THE INVENTION

1. Field of the Invention

The present invention relates generally to a communication apparatus, an equipment message processing program and a computer readable medium, and particularly to a communication apparatus that manages communication equipment (devices) that are connected to a network.

2. Description of the Related Art

SNMP (Simple Network Management Protocol) is known as a communication protocol used in a TCP/IP network for monitoring/controlling communication devices such as a printer, a scanner, a router, a computer, and/or a terminal that are connected to the network. In SNMP, communication is established between a manager and an agent. A manager corresponds to software implemented in a computer that is configured to manage and monitor communication equipment. An agent corresponds to a function of a communication device for reporting to the manager its current state.

It is noted that messages are exchanged between a manager and an agent, and a TRAP corresponds to one type of such messages that is transmitted from the agent to the manager to inform the manager of a state change such as an error occurring at the agent side. A TRAP corresponds to a message that is spontaneously (voluntarily) transmitted by an agent experiencing a state change such as an error as opposed to a message that is transmitted in response to a request from the manager. In this way, the manager may be informed of a state change of a communication device (agent) in real time through receiving a TRAP from the communication device.

However, the port number of a socket for receiving a TRAP at the manager side is limited to one port number (i.e., port 162) so that when plural managers are activated within one computer, the activated managers may have to compete with one another to gain access to the TRAP, and the TRAP may not be shared by the managers. That is, once the TRAP is acquired by one manager from a packet queue, the other managers are unable to acquire the TRAP since the TRAP is already extracted from the packet queue. As a result, the managers may be unable to appropriately monitor the communication equipment connected to the network.

### SUMMARY OF THE INVENTION

The present invention has been conceived in response to one or more of the problems of the related art, and its object is to provide a communication apparatus, an equipment message processing program, and a computer readable medium that enable plural applications to share equipment state information transmitted from equipment connected to a network.

According to an aspect of the present invention, a communication apparatus implementing plural applications is provided, the apparatus including:

an equipment message processing part that is configured to receive a message transmitted from equipment connected to a network which message indicates a state of the equipment, and to transmit message information pertaining to the message to the applications.

In a communication apparatus according to an embodiment of the present invention, equipment state information that is transmitted from equipment connected to a network may be shared by plural applications.

According to another aspect of the present invention, an equipment message processing program is provided that is executed by a computer to realize the functions of the communication apparatus of the present invention. According to another aspect of the present invention, a computer readable medium storing an equipment message processing program of the present invention is provided.

### BRIEF DESCRIPTION OF THE DRAWINGS

FIG. 1 is a block diagram showing a configuration of an equipment management system according to an embodiment of the present invention;

FIG. 2 is a block diagram showing a hardware configuration of an equipment manager apparatus according to an embodiment of the present invention;

FIG. 3 is a block diagram showing a functional configuration of the equipment manager apparatus according to an embodiment of the present invention;

FIG. 4 is a block diagram showing a functional configuration of a network layer according to an embodiment of the present invention;

FIG. 5 is a block diagram showing a functional configuration of a TRAP service according to a first embodiment of the present invention;

FIG. 6 is a diagram illustrating a TRAP information transmission method (event method) that is realized by the TRAP service according to the first embodiment;

FIG. 7 is a diagram illustrating a process flow of operations of the equipment manager apparatus according to the first embodiment;

FIG. 8 is a block diagram showing a functional configuration of a TRAP service according to a second embodiment of the present invention;

FIG. 9 is a diagram illustrating a TRAP information transmission method (spool method) realized by the TRAP service according to the second embodiment;

FIG. 10 is a diagram illustrating a process flow of operations of the equipment manager apparatus according to the second embodiment;

FIG. 11 is a diagram illustrating a process flow of operations of the equipment manager apparatus according to a third embodiment of the present invention;

FIG. 12 is a diagram illustrating a process flow of operations of the equipment manager apparatus according to a fourth embodiment of the present invention; and

FIG. 13 is a diagram illustrating an extraction of TRAP information that satisfies a predetermined transmission condition.

### DESCRIPTION OF THE PREFERRED EMBODIMENTS

In the following, preferred embodiments of the present invention are described with reference to the accompanying drawings.

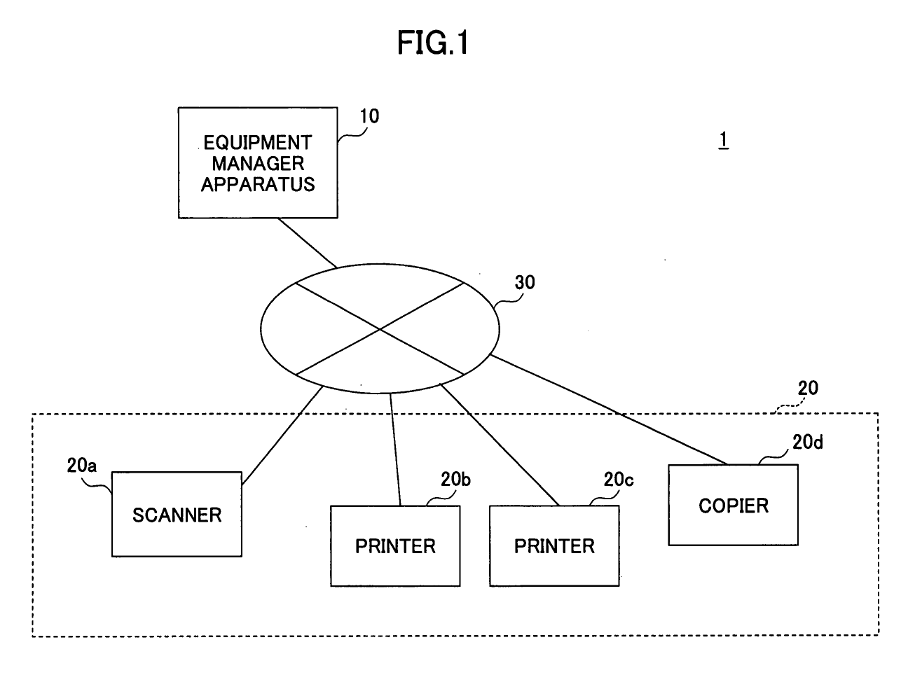

FIG. 1 is a block diagram showing a configuration of an equipment management system according to an embodiment of the present invention. The equipment management system 1 shown in FIG. 1 includes an equipment manager apparatus 10, various network devices such as a scanner 20a, a printer 20b, a printer 20c, and a copier 20d, for example (collectively referred to as ‘equipment 20’), and a network 30 such as a LAN that interconnects the equipment manager apparatus 10 and the equipment 20.

The equipment manager apparatus 10 corresponds to a computer that is provided with various management functions for monitoring the state of the equipment 20 and controlling operations thereof, for example. The equipment 20 corresponds to network equipment that is at least provided with a function for operating as an agent in SNMP communication.

In the following, the equipment manager apparatus 10 is described in greater detail.

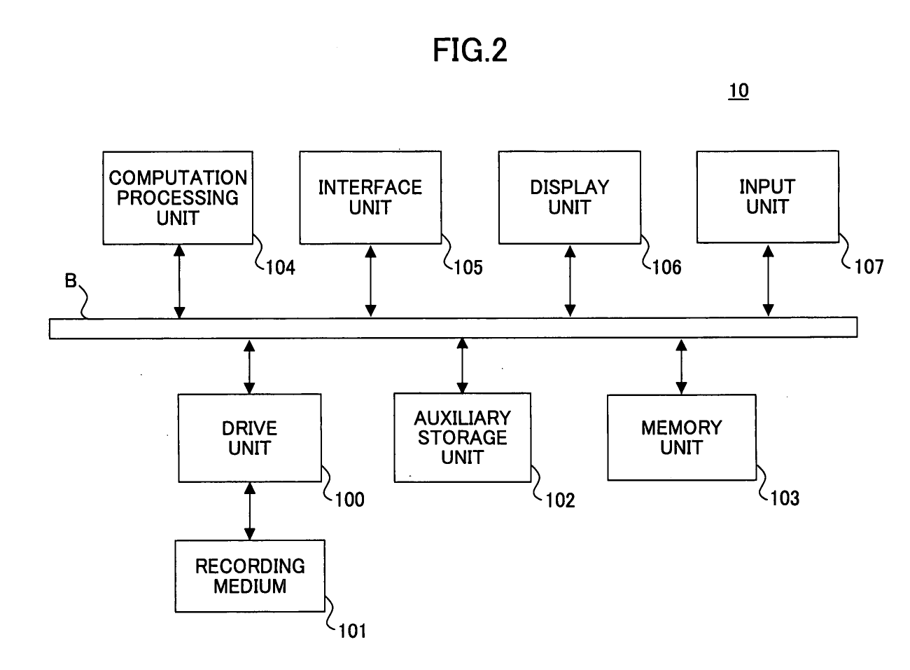

FIG. 2 is a block diagram showing a hardware configuration of the equipment manager apparatus 10 according to an embodiment of the present invention. The equipment manager apparatus 10 shown in FIG. 2 includes a drive unit 100, an auxiliary storage unit 102, a memory unit 103, a computation processing unit 104, an interface unit 105, a display unit 106, and an input unit 107 that are interconnected by a bus B.

A program to be executed by the equipment manager apparatus 10 may be provided by a computer readable medium 101 such as a CD-ROM. The computer readable medium 101 storing such a program is loaded in the drive unit 100 so that the program stored in the computer readable medium 101 may be installed in the auxiliary storage unit 102 via the drive unit 100. The auxiliary storage unit 102 stores a program installed therein as well as various files and data. The memory unit 103 reads and loads a program stored in the auxiliary storage unit 102 in response to a program activation command. The computation processing unit 104 executes a function of the equipment manager apparatus 10 according to the program loaded in the memory unit 103. The interface unit 105 is used as an interface for connecting the equipment manager apparatus 10 to the network 30. The display unit 106 may be arranged to display a GUI (Graphical User Interface) provided by a program, for example. The input unit 107 may include input devices such as a keyboard and a mouse that are used to input various operational commands.

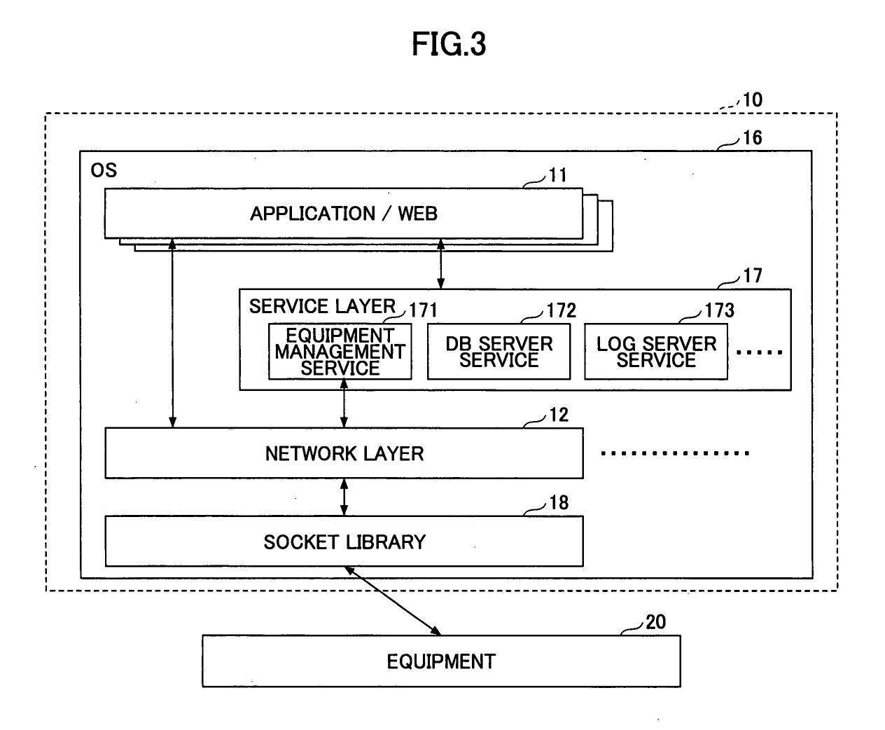

FIG. 3 is a block diagram showing a functional configuration of the equipment manager apparatus according to an embodiment of the present invention. According to FIG. 3, the equipment manager apparatus 10 includes at least one application 11, a service layer 17, a network layer 12, and a socket library 18 that operate on an OS (Operating System) 16.

In the present embodiment, the application 11 is configured to provide various functions for the equipment manager apparatus 10. For example, the application 11 may be directly used by a user such as a network administrator or an equipment operator. In another example, the application 11 may correspond to a so-called Web application. In this regard, the application 11 is indicated as application/Web 11 in the present drawing.

The service layer 17 includes modules for providing predetermined operation logic to an upper layer (i.e., the application 11 in the present embodiment). For example, an equipment management service 171, a DB server service 172, and a log server service 173 may be provided as modules belonging to the service layer 17. The equipment management service 171 corresponds to a module for providing service relating to equipment management. The DB server service 172 corresponds to a module for providing accessing functions with respect to a database (not shown). The log server service 173 corresponds to a module for providing functions relating to recording and management of log information.

In one embodiment, the application 11 may be provided with operation logic such as an equipment management function in which case the application 11 may directly call the network layer 12. In another embodiment, the application 11 may simply be provided with a function of a user interface such as a Web page generating function in which case the application 11 may call a corresponding module of the service layer 17 to execute a designated function. For example, the application 11 may call the equipment management service 171 in order to execute a function relating to equipment management.

The network layer 12 includes modules for providing communication functions (e.g., information acquisition or setting) to the application 11 and the service layer 17 upon establishing communications with the equipment 20.

The socket library 18 provides interface functions relating to TCP/IP network communication control, for example. That is, the network 12 uses the socket library 18 to realize TCP/IP communications.

The OS 16 corresponds to a conventional operating system for realizing operation of the application 11, the service layer 17, the network layer 12, and the socket library 18.

In the following, the network layer 12 is described in greater detail.

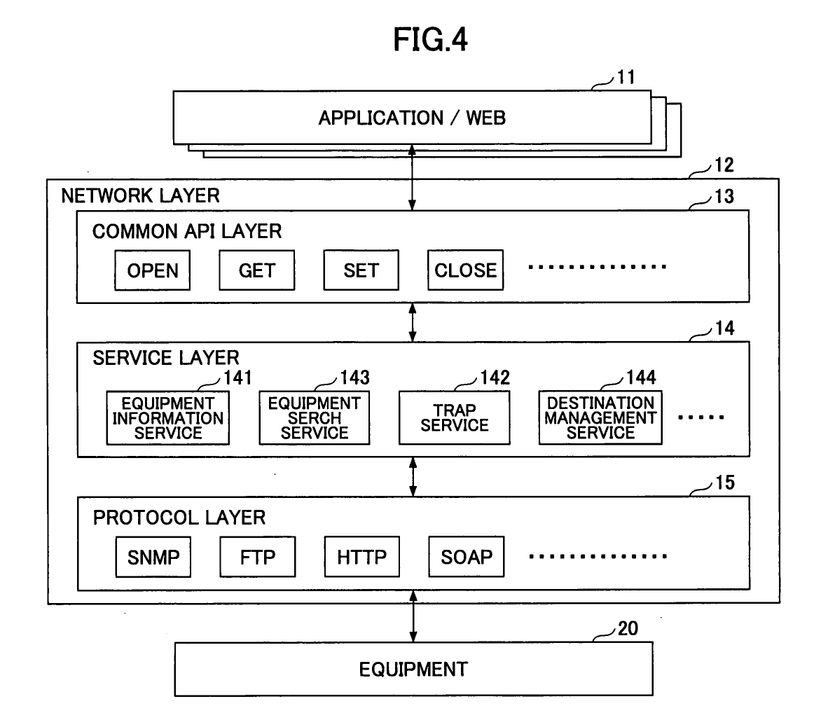

FIG. 4 is a block diagram showing a functional configuration of the network layer 12 according to an embodiment of the present invention. According to FIG. 4, the network layer 12 includes a common API layer 13, a service layer 14, and a protocol layer 15.

The common API layer 13 includes API (Application Program Interface) functions that provide abstract interface functions to the application 11 and/or the service layer 17 that do not depend on the type of information acquired from the equipment 20. For example, the common API layer 13 may include an Open function for starting communications with the equipment 20, a Get function for acquiring information from the equipment 20, a Set function for setting information in the equipment 20, and a Close function for ending communications with the equipment 20. The functions of the common API layer 13 are configured to call the service layer 14 based on an abstract parameter provided by the application 11 (e.g., the type of the desired information) or a parameter controlling the communications (e.g., timeout).

The service layer 14 includes modules providing functions specific to various services such as an equipment information service 141, an equipment search service 143, a TRAP service 142, and a destination management service 144. The equipment information service 141 corresponds to a module providing functions for acquiring from and/or setting various types of information in the equipment 20. The equipment search service 143 corresponds to a module providing search functions for searching for the equipment 20 connected to the network 30. The TRAP service 142 corresponds to a module providing functions for receiving a TRAP (corresponding to a message voluntarily transmitted by the equipment 20 through SNMP communication that indicates the state of the equipment 20), and transmitting the received TRAP to the application 11. The destination management service 144 corresponds to a module for managing information pertaining to a destination in mail transmission, for example. The service layer 14 is configured to call the protocol layer 15 based on an abstract parameter that is provided by the application 11 via the common API layer 13 or a parameter pertaining to the protocol used for establishing communications (e.g., information designating the type of protocol or designating automatic selection thereof), for example.

The protocol layer 15 is configured to provide communication functions to an upper layer (i.e., the service layer 14 in the present example) for realizing communications with the equipment 20 using interfaces depending on respective protocols provided in the protocol layer 15. For example, modules for realizing communications using SNMP (Simple Network Management Protocol), FTP (File Transfer Protocol), HTTP (HyperText Transfer Protocol), and SOAP (Simple Object Access Protocol) may be provided in the protocol layer 15.

In the following, a first embodiment of the present invention is described.

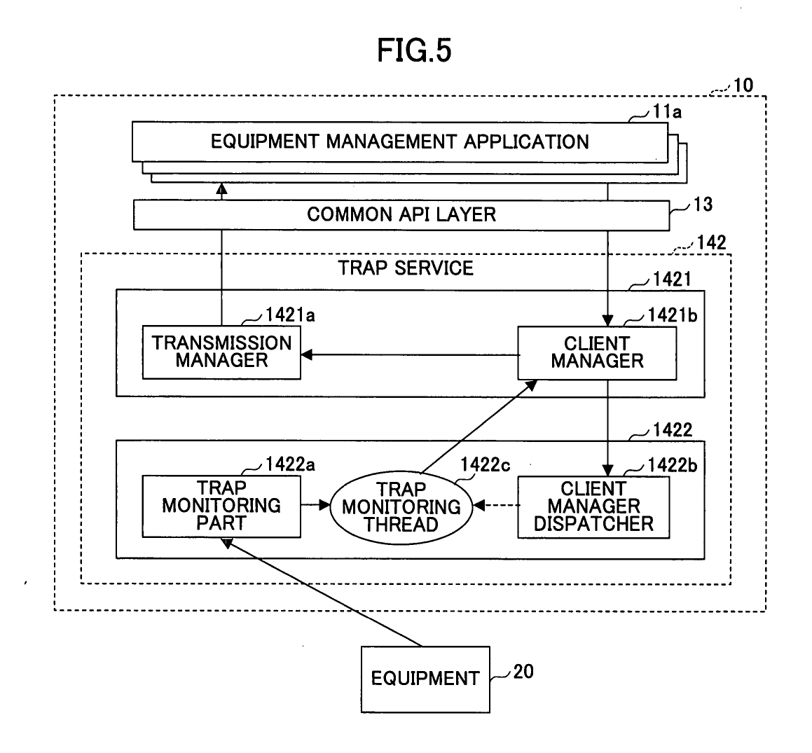

FIG. 5 is a block diagram showing a functional configuration of the TRAP service according to the first embodiment. The trap service 142 of FIG. 5 includes a client module 1421 and a server module 1422. Also, it is noted that in the illustrated example of FIG. 5, an equipment management application 11a is provided as the application 11 of FIG. 3, the equipment management application 11a being configured to use the TRAP service 142 to provide management functions for managing the equipment 20. In the equipment manager apparatus 10 of the present embodiment, parallel operation of plural equipment management applications 11a is realized.

According to the present embodiment, the client module 1421 is provided for each equipment management application 11a and functions as an arbitrator between the server module 1422 and the equipment management application 11a. The client module 1421 includes a transmission manager 1421a and a client manager 1421b. The transmission manager 1421a is configured to transmit a TRAP received by the server module 1422 to a corresponding equipment management application 11a. The client manager 1421b is configured to manage various types of information that are required for transmitting the TRAP to the corresponding equipment management application 11a. For example, the client manager 1421b may receive an information registration request or an information deletion request from the equipment management application 11a, as well as an information acquisition start request, an information acquisition interruption request, and an information acquisition end request from the transmission manager 1421a.

The server module 1422 is configured to receive a TRAP from the equipment 20. In a case where communication with the equipment 20 is realized by SNMP, the server module 1422 functions as a SNMP manager. The server module 1422 is executed as an independent process within the equipment manager apparatus 10, and may be shared by plural client modules 1421. The server module 1422 includes a TRAP monitoring part 1422a, a client manager dispatcher 1422b, and a TRAP monitoring thread 1422c.

The TRAP monitoring part 1422a is configured to receive a TRAP via the sole socket (port) for receiving a TRAP from the equipment 20. The client manager dispatcher 1422b manages/controls interaction with the client module 1421. For example, the client manager dispatcher 1422b may receive an information registration request from the client module 1421 to register identification information of the client 1421. The TRAP monitoring thread 1422c is generated for each client module 1421 by the client management dispatcher 1422b and corresponds to a thread for controlling communications with the client module 1421. As can be appreciated from the above descriptions, the TRAP monitoring part 1422a is shared by plural TRAP monitoring threads 1422c.

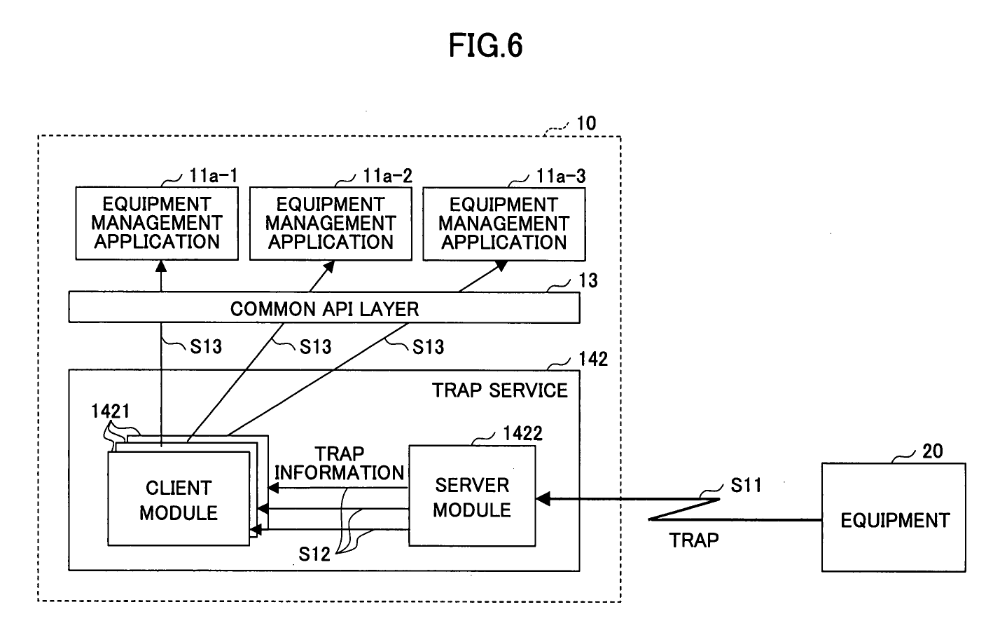

FIG. 6 is a diagram illustrating a TRAP information transmission method (event method) realized by the TRAP service according to the first embodiment. According to the present embodiment, when a TRAP from the equipment 20 is received via a socket (S11), the server module 1422 generates information signaling the reception of the TRAP and indicating the content of the TRAP (referred to as ‘TRAP information’ hereinafter) for each of the client modules 1421 provided for the corresponding one of the equipment management applications 11a-1, 11a-2, and 11a-3, and transmits the TRAP information to the client modules 1421 (S12). In turn, each of the client modules 1421 transmits the received TRAP information to its corresponding equipment management application 11a-1, 11a-2, or 11a-3 (S13). In this way, a TRAP received via one socket may be transmitted to plural equipment applications 11a.

In the following, operation processes executed in the equipment manager apparatus 10 are described.

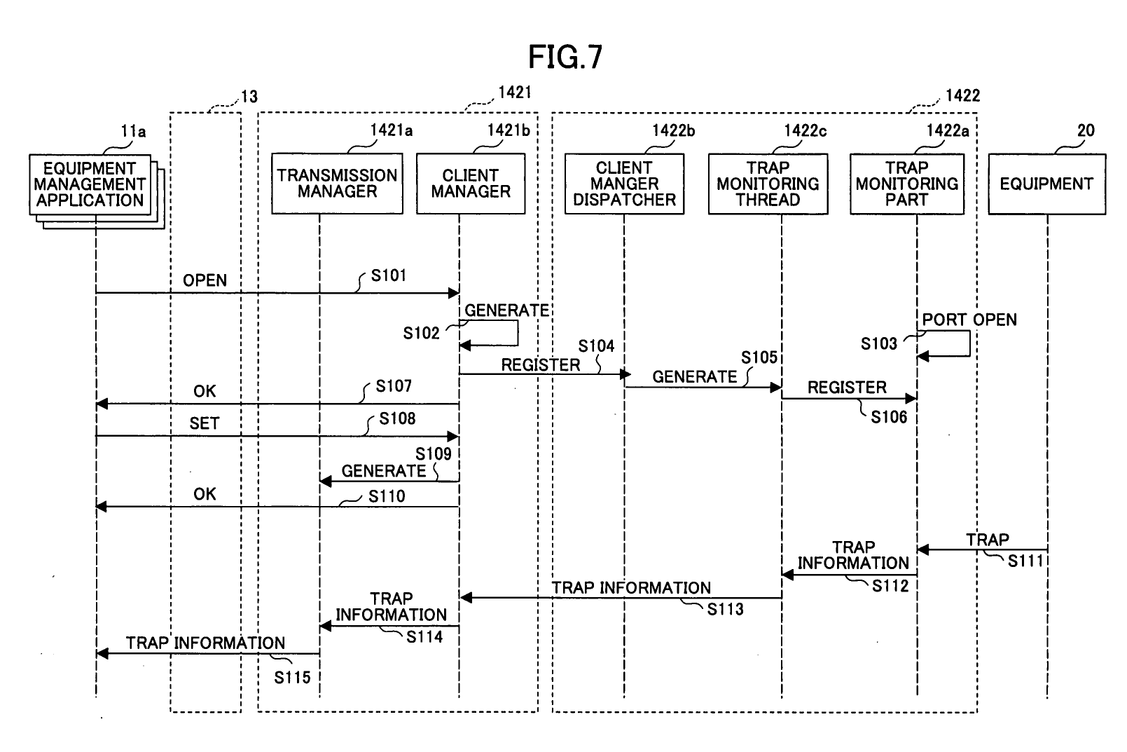

FIG. 7 is a diagram illustrating a process flow of operations of the equipment manager apparatus 10 according to the first embodiment.

Upon being activated, the equipment management application 11a calls the Open function of the common API layer 13 to register its identification information (e.g., process ID) in the client manager 1421b (S101). Then, the client manager 1421b generates (activates) the server module 1422 as an initialization process of the client module 1421 (S102). In turn, the TRAP monitoring part 1422a of the server module 1422 sends a request to the protocol layer 15 to open the port for receiving a TRAP (S103). For example, in the case of receiving a TRAP through SNMP communications, a port with the corresponding port number for realizing SNMP communications is opened. However, it is noted that in a case where the server module 1422 is already activated, the step of generating the server module 1422 and opening the port may be omitted.

After step S103, the operation proceeds to step S104 where the client manager 1421b sends a request to the client manager dispatcher 1422b to register information pertaining to the client module 1421 (referred to as ‘client module information’). The client module information may include the IP address of the apparatus in which the client module 1421 is implemented, a port number that is assigned to the client module 1421, a process number of the client module 1421, and a message ID for identifying a message as that addressed to the client module 1421, for example. The client module information as is described above is used by the TRAP monitoring thread 1422c in a subsequent step for identifying the client manager 1421b upon transmitting TRAP information to the client manager 1421b.

After step S104, the operation proceeds to step S105 where the client manager dispatcher 1422b generates the TRAP monitoring thread 1422c. In turn, the TRAP monitoring thread 1422c registers its identification information in the TRAP monitoring part 1422a so as to be able to receive TRAP information in a subsequent step (S106). Upon completion of the above process steps, the client manager 1421b informs the equipment application 11aof the normal end of the Open function (S107).

In response to the normal end of the Open function, the equipment management application 11acalls the Set function of the common API layer 13 to register information pertaining to a method for transmitting TRAP information from the equipment 20 to the equipment management application 11a(TRAP information transmission method) in the client manager 1421b (S108). It is noted that various transmission methods may be employed as the TRAP information transmission method including the callback method and the message method, for example.

The callback method refers to a transmission method in which the equipment management application 11ais provided with a function for receiving TRAP information (callback function), which callback function is registered in the client manager 1421b. According to this method, upon receiving TRAP information, the client manager 1421b designates the TRAP information as the argument of the registered function and calls the callback function to transmit the TRAP information to the equipment management application 11a.

The message method corresponds to a transmission method in which the equipment management application 11ais provided with a handle for receiving an event message (e.g., Windows (registered trademark) message transmission handle) and an event message ID (e.g., Windows (registered trademark) message transmission ID), which handle and event message ID are registered in the client manager 1421b. According to this method, upon receiving TRAP information, the client manager 1421b transmits a message identified by the registered event message ID to the registered handle.

After step S108, the operation proceeds to step S109 where the client manager 1421b generates the transmission manager 1421a, and informs the equipment application 11aof the normal end of the Set function (S110).

In this way, the initialization processes for the equipment management application 11aare completed. In the following, operation processes executed upon receiving a TRAP from the equipment 20 are described.

The TRAP monitoring part 1422a, upon receiving a TRAP from the equipment 20 (S111), generates TRAP information based on the contents of the received TRAP, and transmits the generated TRAP information to the TRAP monitoring thread 1422c that has been registered in step S106 (S112). In a case where plural equipment applications 11a are activated, namely, if plural client modules 1421 are activated, a TRAP monitoring thread 1422c is registered for each of the activated client modules 1421, and in turn, TRAP information for each of the activated client modules 1421 is generated and output to the corresponding TRAP monitoring thread 1422c. It is noted that TRAP information may include address information of the equipment 20 (e.g., IP address, MAC address), time information, and information for identifying the generated event (e.g., cover open, toner shortage), for example.

After step S112, the operation proceeds to step S113 where the TRAP monitoring thread 1422c identifies the client manager 1421b corresponding to the destination of the TRAP information based on the registered client module information, and transmits the TRAP information to the identified client manager 1421b. After step S113, the operation proceeds to step S114 where the client manager 1421b transmits the received TRAP information to the transmission manager 1421a. After step S114, the operation proceeds to step S115 where the transmission manager 1421a transmits the received TRAP information to the equipment management application 11a based on the TRAP information transmission method pre-registered by the equipment management application 11a.

When the equipment management application 11a no longer requires transmission of TRAP information such as when the equipment management application 11a is shut down, the equipment management application 11a calls the Close function of the common API layer 13. In this way, the various items of information pertaining to this equipment management application 11a registered in the TRAP service 142 are deleted, and the registration of the equipment management application 11a as a TRAP information transmission destination is canceled.

In the following, a second embodiment of the present invention is described. The second embodiment employs a TRAP information transmission method that is different from that used in the first embodiment to enable the sharing of TRAP information among plural equipment management applications 11a.

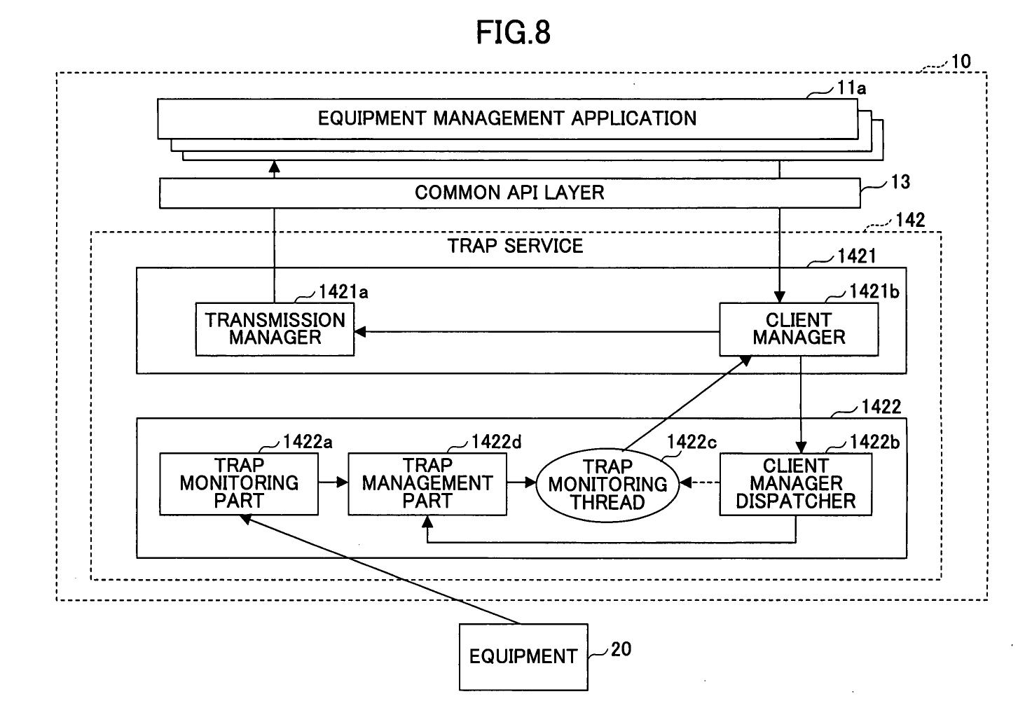

FIG. 8 is a block diagram showing a functional configuration of a TRAP service according to the second embodiment of the present invention. It is noted that in FIG. 8, components that are identical to those shown in FIG. 5 are assigned the same references, and their descriptions are omitted. In the embodiment of FIG. 8, a TRAP management part 1422d is provided in the server module 1422. The TRAP management part 1422d is configured to store (spool) TRAP information that is generated by the TRAP monitoring part 1422a based on TRAPs received from the equipment 20.

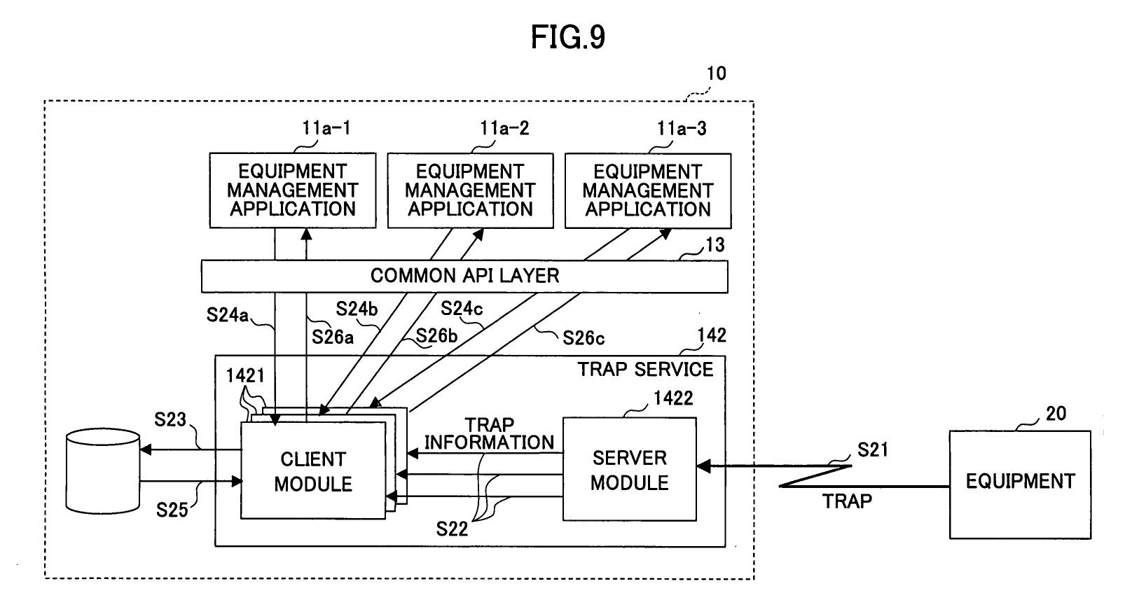

FIG. 9 is a diagram illustrating a TRAP information transmission method (spool method) realized by the TRAP service according to the second embodiment.

According to the second embodiment, when a TRAP is received from the equipment 20 via a socket (S21), the server module 1422 generates TRAP information for each of the client modules 1421 provided for the corresponding one of the equipment management applications 11a that are currently activated, and transmits the TRAP information to each of the client modules 1421 (S22). In turn, the client modules 1421 spool the received TRAP information in a predetermined storage area (S23). Then, in response to periodic requests from the equipment management applications 11a (S24a, S24b, and S24c), the client modules 1421 retrieve the spooled TRAP information (S25), and transmit the TRAP information to their corresponding equipment management applications 11a (S26a, S26b, and S26c). In this way, a TRAP received via one socket may be transmitted to plural equipment management applications 11a.

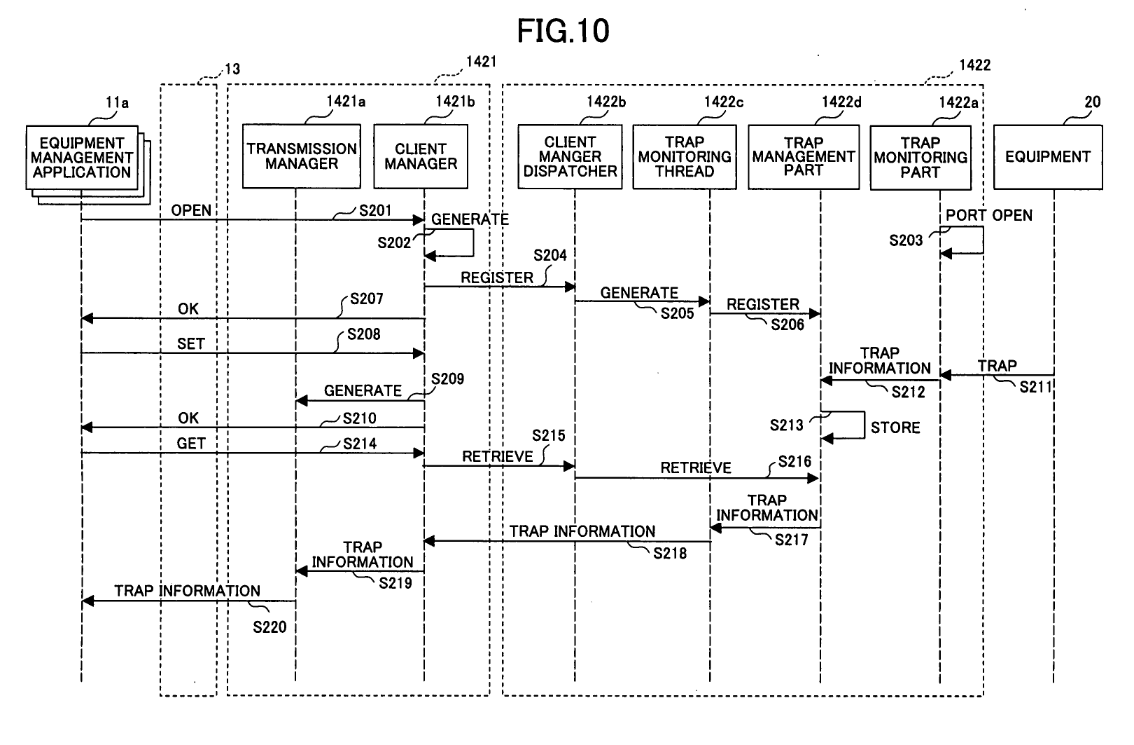

FIG. 10 is a diagram illustrating operations of the equipment manager apparatus 10 according to the second embodiment. It is noted that in this drawing, steps S201 through S210 corresponding to initialization process operations of the equipment management application 11a are identical to the process steps S101 through S110 of FIG. 7 that are described in relation to the first embodiment, and thereby, their descriptions are omitted.

The TRAP monitoring part 1422a, upon receiving a TRAP from the equipment 20 (S211), generates TRAP information based on the contents of the received TRAP, and outputs the generated TRAP information to the TRAP management part 1422d (S212). After step S212, the operation proceeds to step S213 where the TRAP management part 1422d spools the received TRAP information in a predetermined storage area such as the auxiliary storage unit 102 or the memory unit 103 (S213). In this way, process operations executed in response to receiving a TRAP from the equipment 20 are completed.

Then, the equipment management application 11a may call the Get function of the common API layer 13 to request for the transmission of the TRAP information (S214). In turn, the client manager 1421b transmits a TRAP information retrieval request to the client manager dispatcher 1422b along with its corresponding client module information (e.g., IP address, port number and process number of client module) (S215).

After step S215, the operation proceeds to step S216 where the client manager dispatcher 1422b transmits the TRAP information retrieval request with the client module information to the TRAP management part 1422d. In turn, the TRAP management part 1422d retrieves the TRAP information stored in the storage area, and outputs the retrieved TRAP information to the TRAP monitoring thread 1422c associated with the client module 1421 corresponding to the sender of the TRAP information retrieval request (S217). It is noted that the TRAP monitoring thread 1422 associated with the client module 1421 requesting for the TRAP information may be identified based on the client module information transmitted along with the TRAP information retrieval request.

In steps S218 through S220 of the present embodiment, the TRAP information is transmitted to the equipment management application 11a in a manner identical to the process steps S113 through S115 of FIG. 7 that are described in relation to the first embodiment.

As can be appreciated from the above descriptions, according to the first embodiment and the second embodiment, a TRAP received via one socket may be transmitted to plural equipment management applications 11a in the equipment manager apparatus 10. Thereby, the equipment management applications 11a may not have to compete with one another to gain access to the received TRAP, and the occurrence of missing information in the equipment management applications 11a may be avoided.

It is noted that in the operations of the equipment manager apparatus according to the first embodiment (FIG. 7), TRAP information corresponding to each TRAP that is received from the equipment 20 is transmitted to each of the equipment management applications 11a. However, in some cases, an equipment management application 11a may only require transmission of TRAP information that satisfies a predetermined condition.

In this regard, a third embodiment of the present invention is described below in which TRAP information is filtered and selectively transmitted to the equipment management application 11a.

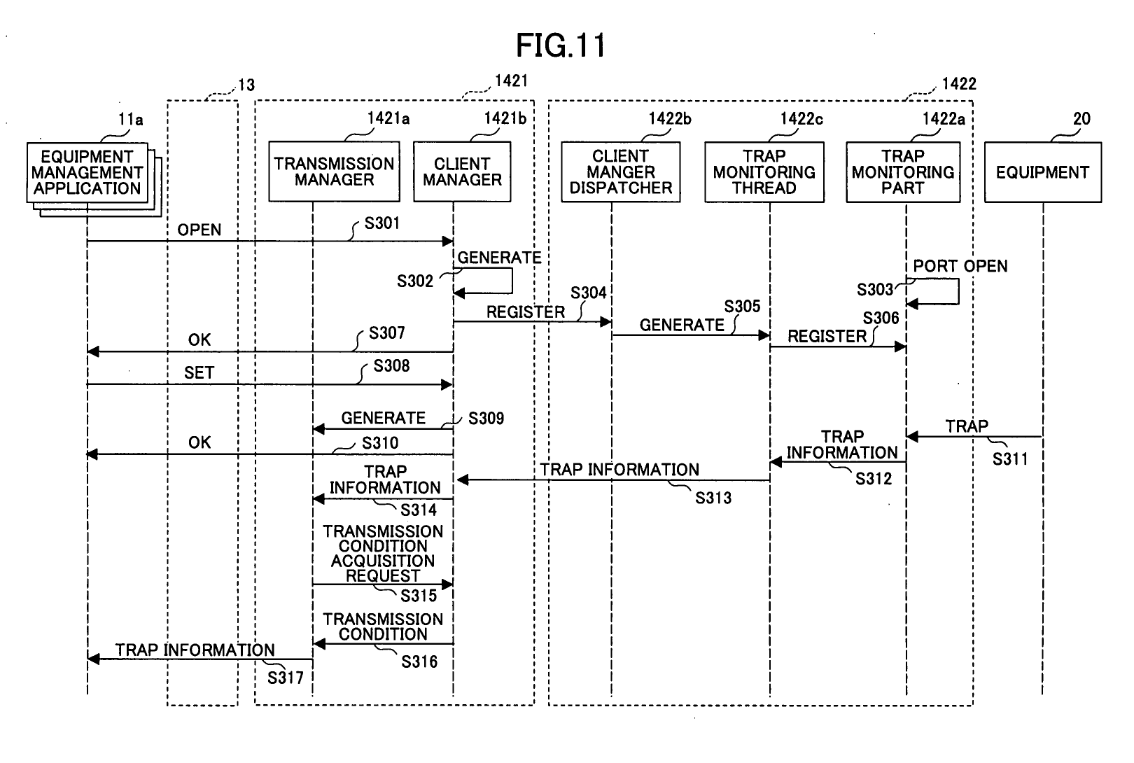

FIG. 11 is a diagram illustrating a process flow of operations of the equipment manager apparatus according to the third embodiment.

In FIG. 11, steps S301 through S310 corresponding to initialization process steps are generally identical to steps S101 through S110 of FIG. 7. However, according to the present embodiment, in step S308, the equipment management application 11a registers a condition for limiting the TRAP information to be transmitted (referred to as ‘transmission condition’ hereinafter) as well as the TRAP information transmission method in the client manager 1421b. The transmission condition may limit the TRAP information to be transmitted to TRAP information for a specific IP address, TRAP information indicating an error, or other specific types of TRAP information, for example.

Then, when a TRAP is received from the equipment 20 (S311), and the corresponding TRAP information is transmitted to the transmission manager 1421a in a manner identical to the process steps S112 through S114 of FIG. 7 (S312-S314), the transmission manager 1421a sends a request to the client manager 1421b to provide the transmission condition (S315), and acquires the transmission condition from the client manager 1421b (S316).

After step S316, the operation proceeds to step S317 where the transmission manager 1421a determines whether the transmitted TRAP information satisfies the transmission condition. If the transmission condition is satisfied, the TRAP information is transmitted to the equipment management application 11a. If the transmission condition is not satisfied, the TRAP information is not transmitted to the equipment management application 11a.

As is described above, according to the third embodiment of the present invention, pertinent TRAP information may be transmitted to each equipment management application 11a of the equipment manager apparatus 10 so that usability of the equipment management application 11a may be improved.

It is noted that in the operation processes of the equipment manager apparatus 10 according to the second embodiment (FIG. 10), TRAP information corresponding to each TRAP that is received from the equipment 20 is transmitted to each equipment management application 11a as is the case with the first embodiment. Also, it is noted that in the second embodiment, the TRAP information is temporarily stored (spooled) so that the TRAP information transmission may lack real-timeliness, and measures may not be provided for appropriately handling a case in which an urgent TRAP is generated, for example. Also, since the TRAP information is accumulated in a storage area such as the auxiliary storage unit 102, the storage capacity of the storage area may be limited so that there may be cases in which newly generated TRAP information may not be spooled due to a shortage of storage space, for example. It is noted that in a case where TRAP information corresponding to plural TRAPs received from the same equipment 20 are accumulated in a storage area, it may be convenient to be able to select whether to designate all the accumulated TRAP information as TRAP information to be transmitted to the equipment management application 11a, or designate the latest TRAP information as TRAP information to be transmitted to the equipment management application 11a, for example.

In the following, a fourth embodiment of the present invention that realizes such a designation of TRAP information to be transmitted is described.

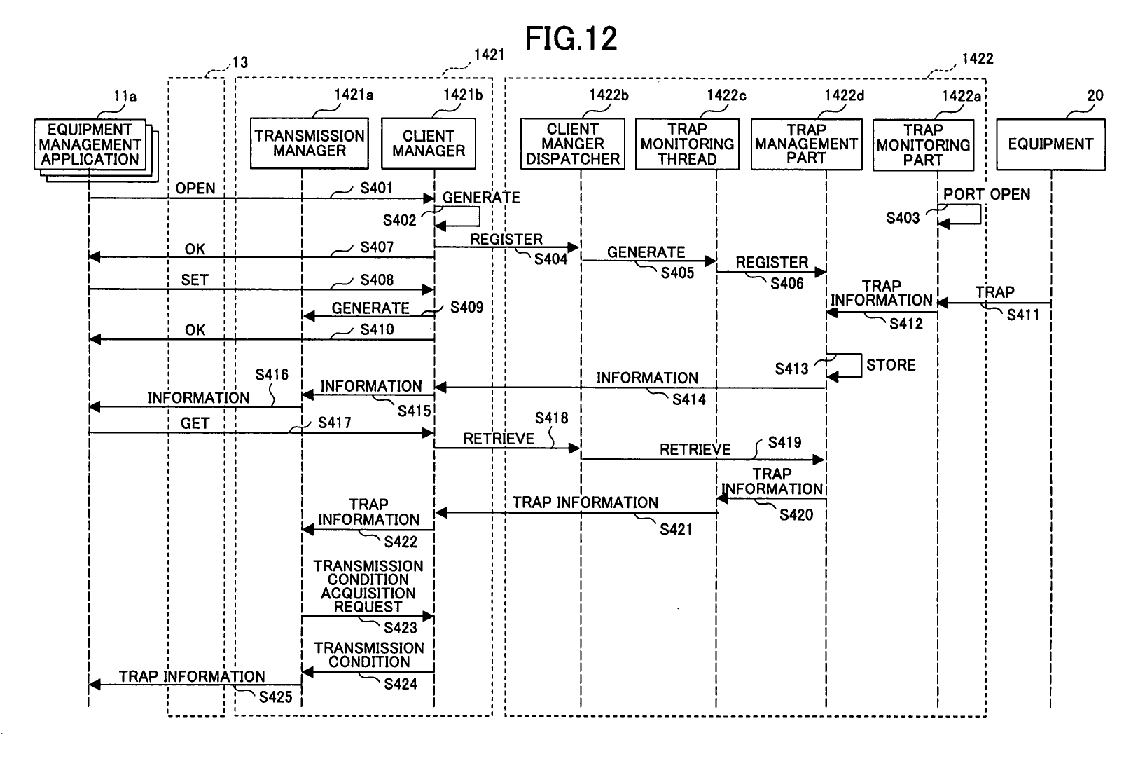

FIG. 12 is a diagram illustrating operation processes of the equipment manager apparatus 10 according to the fourth embodiment.

In FIG. 12, steps S401 through S410 corresponding to initialization processes of the equipment management application 11a are generally identical to the process steps S201 through S210 of FIG. 10. However, according to the fourth embodiment, in step S406, the TRAP monitoring thread 1422c registers identification information of the client manager 1421b associated with this TRAP monitoring thread 1422c in the TRAP management part 1422d along with its own identification information. In this way, in a subsequent step S414 described below, the client management part 1421b may be informed by the TRAP management part 1422d that TRAP information has been stored (spooled). Also, in step S408, the equipment management application 11a registers the TRAP information transmission method as well as the transmission condition in the client manager 1421b. The transmission condition may include one or more of the conditions described in relation to the third embodiment as well as a condition relating to whether the latest TRAP information is designated as the TRAP information to be transmitted.

Then, when a TRAP from the equipment 20 is received by the TRAP monitoring part 1422a (S411), the TRAP management part 1422d receives TRAP information corresponding to the received TRAP (S412), and spools the TRAP information in a storage area (S413). In the present embodiment, the TRAP management part 1422d deletes TRAP information for which a pre-designated storage period has already expired. In this way, congestion of the storage area may be avoided. It is noted that the storage period may be set by the equipment management application 11a, for example.

After step S413, the operation proceeds to step S414 where the TRAP management part 1422d transmits a message to the client manager 1421b indicating that the TRAP information has been spooled (referred to as ‘spool message’ hereinafter). In turn, the client manager 1421b transmits the spool message to the transmission manager 1421a (S415), and the transmission manager 1421a transmits the spool message to the equipment management application 11a according to the registered TRAP information transmission method (S416). On the other hand, in a case where the TRAP information cannot be stored in the storage area due to a shortage of storage space, instead of transmitting the spool message, a message indicating the failure to store the TRAP information (referred to as ‘spool error message’ hereinafter) is transmitted from the TRAP management part 1422d to the equipment management application 11a via the transmission manager 1421a and the client manager 1421b. In turn, the equipment management application 11a may inform the user of the spool error so that the user may take necessary measures such as securing storage space for spooling the TRAP information.

Upon being informed that the TRAP information has been spooled based on the spool message, the equipment management application 11a calls the Get function of the common API layer 13 to request for the transmission of the TRAP information (S417). In turn, the TRAP information is retrieved and transmitted to the transmission manager 1421a through process steps that are identical to the process steps S215 through S219 of FIG. 10 (S418-S422).

Then, the transmission manager 1421a sends a request to the client manager 1421b to provide the transmission condition (S423) and acquires the transmission condition from the client manager 1421b (S424). After step S424, the operation proceeds to step S425 where the transmission manager 1421a extracts TRAP information that satisfies the transmission condition, and transmits the extracted TRAP information to the equipment management application 11a.

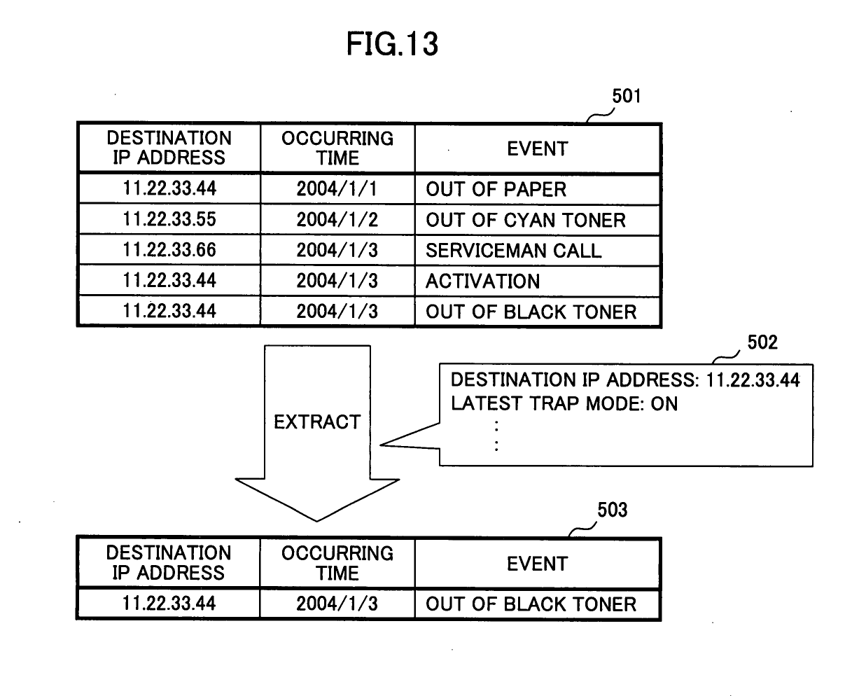

FIG. 13 is a diagram illustrating the extraction of TRAP information that satisfies a predetermined transmission condition.

In the illustrated example of FIG. 13, transmission condition 502 is used to extract TRAP information 503 from plural sets of TRAP information 501. The transmission condition 502 designates TRAP information with destination IP address 11.22.33.44 to be transmitted, and sets the latest TRAP mode to ON mode (i.e. designates only the latest TRAP information to be transmitted). Thus, the latest TRAP information item of the TRAP information items with the destination IP address 11.22.33.44 included in the TRAP information 501 is extracted as TRAP information 503.

As is described above, according to the fourth embodiment, a message indicating that TRAP information has been spooled is transmitted to each equipment management application 11a in real time in the equipment manager apparatus 10, and thereby, the equipment management application 11a may be notified of the existence of TRAP information at the time of its generation. Also, conditions may be provided including whether only the latest TRAP information is to be transmitted, and TRAP information satisfying the conditions may be selectively transmitted to the equipment management application 11a so that usability of the equipment management application 11a may be improved. Further, a storage period may be set to the spooled TRAP information, and when the set storage period of TRAP information expires, the TRAP information may be automatically deleted. In this way, situations in which newly generated TRAP information cannot be spooled due to a shortage of storage space may be avoided.

According to an embodiment, one or more operations of the equipment manager apparatus 10 may be realized by a program in the form of software or code, for example, that may be embodied in any computer readable medium for use by or in connection with an instruction execution system such as, for example, a processor in a computer system or other system. In this sense, the program may comprise, for example, statements including instructions and declarations that can be fetched from the computer readable medium and executed by the instruction execution system. In the context of the present invention, a ‘computer readable medium’ can be any medium that can contain, store, or maintain the program for use by or in connection with the instruction execution system. The computer readable medium can comprise any one of many physical media such as, for example, electronic, magnetic, optical, electromagnetic, infrared, or semiconductor media. More specific examples of a suitable computer readable medium includes, but are not limited to, magnetic tapes, magnetic floppy diskettes, magnetic hard drives, or compact discs. Also, the computer readable medium may be a random access memory (RAM) including, for example, static random access memory (SRAM) and dynamic random access memory (DRAM), or magnetic random access memory (MRAM). In addition, the computer readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

The present application is based on and claims the benefit of the earlier filing date of Japanese Patent Application No.2004-172792 filed on Jun. 10, 2004, and Japanese Patent Application No.2005-134258 filed on May 2, 2005, the entire contents of which are hereby incorporated by reference.

What is claimed is:

1. A communication apparatus implementing a plurality of applications, the apparatus comprising:
an equipment message processing part that is configured to receive a message transmitted from equipment connected to a network which message indicates a state of the equipment, and transmit message information pertaining to the message to the applications.

2. The communication apparatus as claimed in claim 1, wherein
the equipment message processing part includes
a plurality of individual message processing parts individually provided for the applications; and
a common message processing part that is shared by the individual message processing parts and is configured to receive the message from the equipment; wherein
the common message processing part is configured to generate the message information for each of the individual message processing parts based on the received message, and transmit the generated message information to the individual message processing parts; and
at least one of the individual message processing parts is configured to transmit the message information to the application corresponding to said at least one of the individual message processing parts.

3. The communication apparatus as claimed in claim 1, wherein
the equipment message processing part is configured to store the message information in a predetermined storage area, and transmit the stored message information to at least one of the applications in response to a request from said at least one of the applications.

4. The communication apparatus as claimed in claim 1, wherein the message processing part is configured to determine whether the message information satisfies a pre-designated condition, and transmit the message information to at least one of the applications if the message information satisfies the pre-designated condition.

5. An equipment message processing program run on an instruction execution system included in a communication apparatus that implements a plurality of applications, the program being executed by the instruction execution system to perform the steps of:
receiving a message transmitted from equipment connected to a network which message indicates a state of the equipment; and
transmitting message information pertaining to the received message to the applications.

6. A computer readable medium that stores an equipment message processing program run on an instruction execution system included in a communication apparatus that implements a plurality of applications, the program being executed by the instruction execution system to perform the steps of:
receiving a message transmitted from equipment connected to a network which message indicates a state of the equipment; and
transmitting message information pertaining to the received message to the applications.
